(19) United States
(12) Patent Application Publication
(10) Pub. No.: US 2016/0078262 A1
(43) Pub. Date: Mar. 17, 2016

(54) LOGISTICS SYSTEM

(71) Applicant: HON HAI PRECISION INDUSTRY CO., LTD., New Taipei (TW)

(72) Inventor: ZONG-YUAN SUN, New Taipei (TW)

(21) Appl. No.: 14/611,640

(22) Filed: Feb. 2, 2015

(30) Foreign Application Priority Data
Sep. 12, 2014 (CN) 201410461614.X

(51) Int. Cl. G06K 7/10; G06Q 10/08

(52) U.S. Cl. CPC G06K 7/10425; G06Q 10/087

(57) ABSTRACT

A logistics system wirelessly communicates with an internet of things (ITO) system. The logistics system includes a tag unit, a data collection unit and a control unit. The tag unit is coupled to goods and storing tag information of the goods. The data collection unit is coupled to a vehicle and configured to read the tag information of the goods from the tag unit and determine loading status of the goods. The control unit wirelessly communicates with the data collection unit and the ITO system, the control unit receiving the tag information and the loading status of the goods from the data collection unit and synchronizes to the ITO system.

### FIELD

The subject matter herein generally relates to a logistics system, and particularly relates to a logistics system for vehicles loading and unloading goods.

### BACKGROUND

Radio frequency identification (RFID) technology is used in goods management business. RFID devices are normally arranged on a front of trucks and industry computer terminals are placed in the trucks, the RFID devices are electrically connected to the industry computer terminals via cables for being identified by RFID devices arranged in storehouses. However, the cables may affect the trucks and easily be compromised after extended use.

### BRIEF DESCRIPTION OF THE DRAWINGS

Implementations of the present technology will now be described, by way of example only, with reference to the attached figures.

FIG. 1 is a block diagram of an exemplary embodiment of a logistics system.

FIG. 2 is a diagrammatic view of the logistics system showing antennas positioned on a vehicle.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

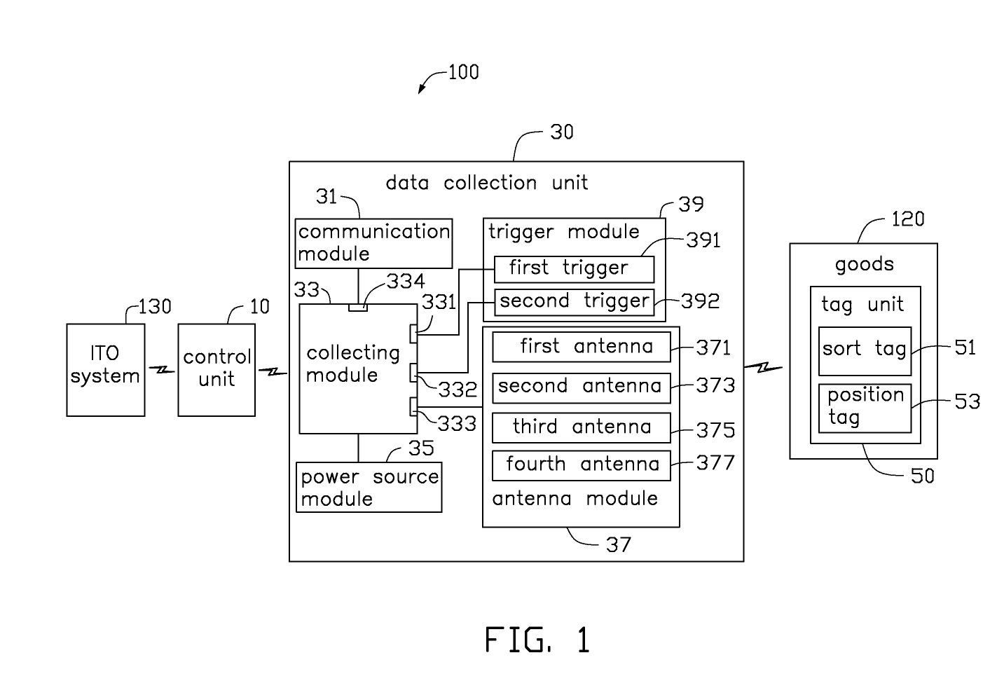

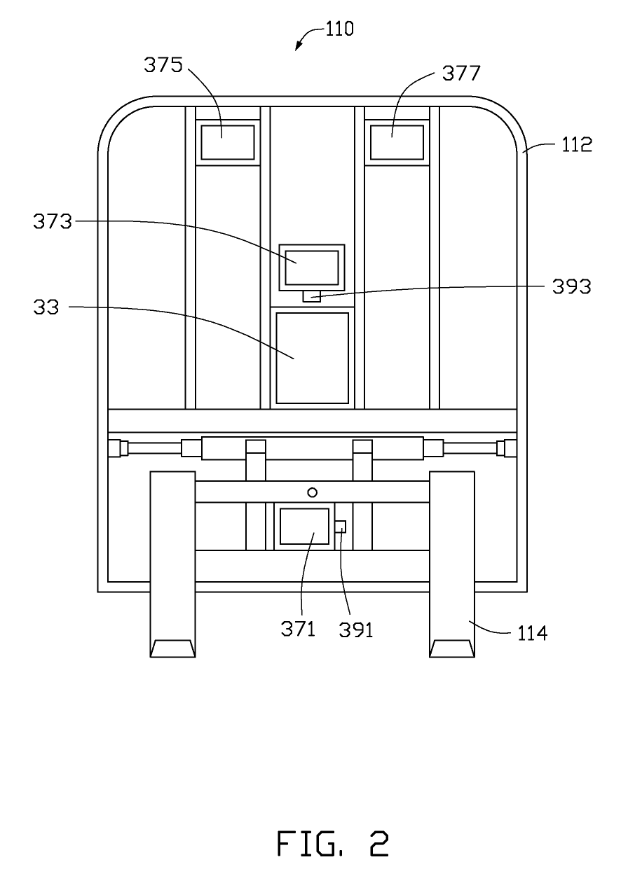

FIGS. 1 and 2 illustrate at least one embodiment of a logistics system 100 applied in vehicles 110 and goods 120 and can be wirelessly connected to an internet of things (IOT) system 130. The goods 120 are stored in a storehouse, the vehicles 110 are configured to deliver the goods 120. The logistics system 100 is configured to manage and search the goods 120 and synchronize goods information, such as a loading vehicle number, a goods type, and a storage location, to the IOT system 130. In at least one embodiment, the vehicles 110 can be forklift trucks, rack supported retrieval machines, and pallet trucks used in industry delivery. The vehicle 110 includes a carrying rack 112 and a lifting fork 114 coupled to the carrying rack 112. The carrying rack 112 is positioned on a front of the vehicle 110. The lifting fork 114 is configured to load and unload the goods 120.

The logistics system 100 includes a control unit 10, a data collection unit 30, and a tag unit 50. The control unit 10 and the data collection unit 30 are coupled to the vehicle 110. The tag unit 50 is coupled to the goods 120 configured to store tag information of the goods 120. The data collection unit 30 is configured to read the tag information from the tag unit 50 and capture status of the goods 120, and further synchronizes the tag information and the status of the goods 120 to the IOT system 130. The tag unit 50 includes a sort tag 51, storing sort information of the goods 120, and a position tag 53, storing position information of the goods 120.

The control unit 10 is an industrial personal computer (IPC) mounted in a driver's cab of the vehicle 110 and provides parameter of the logistics system 100 to the driver. In at least one embodiment, the control unit 10 at least includes a Bluetooth® module, a Wi-Fi module, and a wireless communication module for communicating with the data collection unit 30 and the IOT system 130.

The data collection unit 30 is coupled to a carrying rack 112 of the vehicle 110 and includes a communication module 31, a collecting module 33, a power source module 35, an antenna module 37, and a trigger module 39. The collecting module 33 is electrically connected to the communication module 31, the power source module 35, the antenna module 35 and the trigger module 39. The communication module 31 is configured to communicate with the control unit 10. In at least one embodiment, the communication module 31 can be a Bluetooth® module. The power source module 35 is configured to provide power for the data collection unit 30. In at least one embodiment, the power source module 35 can be a hot-swappable rechargeable battery.

The collecting module 33 is coupled to a centre position of the carrying rack 112 of the vehicle 110 and at least includes a first trigger interface 331, a second trigger interface 332, a four-channel Sub-Miniature-A (SMA) interface 333 and a communication interface 334. The first trigger interface 331 and the second trigger interface 332 are electrically connected to the trigger module 39 for receiving trigger signals from the trigger module 39. The four-channel SMA interface 333 is electrically connected to the antenna module 37 for tag information of the goods read by the antenna module 37. The communication interface 334 is electrically connected to the communication module 31 for communicating with the communication module 31.

The antenna module 37 includes a first antenna 371, a second antenna 373, a third antenna 375 and a fourth antenna 377 electrically connected to the four-channel SMA interface 333, respectively. The first antenna 371 is mounted on the carrying rack 112 and positioned within the lifting fork 114. The second antenna 373 is adjacent to the collecting module 33. The first antenna 371 and the second antenna 373 are configured to read sort information from the sort tag 51 of the goods 120 on the vehicle 110. The third antenna 371 and the fourth antenna 373 are arranged on two top corners of the carrying rack 112, respectively, and are configured to read sort information from the sort tag 51 and position information from the information tag 53 of the goods 120 stored in the storehouse, therefore quickly positioning the goods 120 in the storehouse.

The trigger module 39 is configured to identify a loading status of the goods 120 and further triggers the antenna module 37 to read information from the tag unit 50 according to the loading status. The trigger module 39 includes a first trigger 391 and a second trigger 392 coupled to the first trigger interface 331 and the second trigger interface 332 of the collecting module 33, respectively, and configured to transmit trigger signals to the collecting module 33. In at least one embodiment, the first trigger 391 and the second trigger 392 are infrared detectors. The first trigger 391 is adjacent to the first antenna 371 and the second trigger 393 is adjacent to the second antenna 373. When the first trigger 391 and the second trigger 392 detect goods 120 approaching, and therefore output a high level (logic 1) trigger signal to the collecting module 33. When the first trigger 391 and the second trigger 392 do not detect goods 120 approaching, and therefore output a low level (logic 0) trigger signal to the collecting module 33. The collecting module 33 triggers the first antenna 371, the second antenna 373, the third antenna 375, or the fourth antenna 377 to read tag information of the goods 120 according to the trigger signal received from the first trigger 391 and the second trigger 392.

When the first trigger interface 331 of the collecting module 33 receives trigger signals from low level signal to high level signal, that is the first trigger 391 detects that goods 120 are approaching, that indicates the goods 120 is loading to the vehicle 110; the collecting module 33 triggers the first antenna 371 to continuously read sort information from the sort tag 51 of the goods 120 in a predetermined period. Specially, in this predetermined period, a sort tag 51 with a greatest signal intensity is preferably read the sort information therefrom. When the first trigger interface 331 and the second trigger interface 332 of the collecting module 33 both receive trigger signals from low level signal to high level signal, that is the first trigger 391 and the second trigger 392 both detect goods 120 approaching, that indicates the two units of goods 120 are loading to the vehicle 110; the collecting module 33 triggers the first antenna 371 and the second antenna 373 to continuously read sort information from sort tags 51 of the two units of goods 120 in a predetermined period, respectively. When both the first trigger interface 331 and the second trigger 392 interface of the collecting module 33 receive trigger signals from high level signal to low level signal, or the first trigger interface 331 receives trigger signals from high level signal to low level signal and the second trigger interface 332 receives continuous low lever trigger signals, that is the first trigger 391 detects goods 120 being unloaded; the collecting module 33 triggers the third antenna 375 and the fourth antenna 377 to continuously read position information from the position tag 53 of the goods 120 in a predetermined period. In addition, the third antenna 375 and the fourth antenna 377 continuously read sort information from the sort tag 51 of the goods 120 in the predetermined period. The collecting module 33 determines positions of the goods 120 in the storehouse according to the position information and the sort information read by the third antenna 375 and the fourth antenna 377. Therefore, the collecting module 33 can capture load and unload status of the goods 120 according to the determined positions. When the first trigger interface 331 and the second interface continuously receives same level trigger signals in a predetermined period, the collecting module 33 automatically turn to a standby mode for saving power.

The collecting module 33 transmits the position information and the sort information of the goods 120 to the control unit 10 via the communication module 31. The control unit 10 can further synchronize the position information and the sort information to the ITO system 130 via wireless network. Therefore, the information of the goods 120 can be well managed by the driver of the vehicle 110 and operators of the ITO system 130.

In one embodiment, a reading range of the data collection unit 30 to the tag unit 50 can be adjusted by radiation frequency of the tag unit 50 and the antenna module 37.

The collecting module 30 is coupled to the carrying rack 112 of the vehicle 110, the control unit 10 is coupled to the driver's cab of the vehicle 110 and wirelessly communicated with the collecting module 30. Thus, the wireless connection between the collecting module 30 and the control unit 10 in different parts of the vehicle 110 increases stability and service life. In addition, the logistics system 100 includes the trigger module 39 for detecting load and unload status of the goods 120, thereby triggering the antenna module 37 to read the information from the tag module 50 on the goods 120. Therefore, the logistics system 100 can conveniently and efficiently search and assort the goods 120.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. A logistics system wirelessly communicated with an internet of things (ITO) system, the logistics system comprising:
a tag unit coupled to goods and configured to store tag information of the goods;
a data collection unit coupled to a vehicle and configured to read the tag information of the goods from the tag unit and determine loading status of the goods; and
a control unit wirelessly communicating with the data collection unit and the ITO system, the control unit receiving the tag information and the loading status of the goods from the data collection unit and synchronizing to the ITO system.

2. The logistics system as claimed in claim 1, wherein the tag unit comprises a sort tag and a position tag; the sort tag is configured to store sort information of the goods, and the position tag is configured to store position information of the goods.

3. The logistics system as claimed in claim 2, wherein the data collection unit comprises a communication module, a collecting module, a power source module, an antenna module and a trigger module; the trigger module is electrically connected to the communication module, the antenna module and the trigger module.

4. The logistics system as claimed in claim 3, wherein the power source module is configured to provide power for the data collection unit; the communication module is configured for being wirelessly communicated with the control unit.

5. The logistics system as claimed in claim 3, wherein the collecting module comprises a first trigger interface, a second trigger interface, a four-channel Sub-Miniature-A (SMA) interface and a communication interface; the first trigger interface and the second trigger interface are electrically connected to the trigger module for receiving trigger signals from the trigger module; the four-channel SMA interface is electrically connected to the antenna module for the tag information of the goods from the antenna module; the communication interface is electrically connected the communication module for communicating with the communication module.

6. The logistics system as claimed in claim 5, wherein the antenna module comprises a first antenna, a second antenna, a third antenna and a fourth antenna electrically connected to the four-channel SMA interface, respectively; the first antenna and the second antenna are configured to read sort information from the sort tag of the goods on the vehicle; the third antenna and the fourth antenna are configured to read sort information from the sort tag and position information from the information tag of the goods.

7. The logistics system as claimed in claim 6, wherein the collecting module is coupled to a center of a carrying rack of the vehicle; the first antenna is mounted on a carrying rack and positioned within a lifting fork of the vehicle, the second antenna is adjacent to the collecting module, the third antenna and the fourth antenna are arranged on two top corners of the carrying rack, respectively.

8. The logistics system as claimed in claim 7, wherein the trigger module is configured to identify the loading status of the goods and further triggers the antenna module to read the tag information from the tag unit according to the loading status; the trigger module comprises a first trigger and a second trigger electrically connected to the first trigger interface and the second trigger interface, respectively, and configured to transmit trigger signals to the collecting module.

9. The logistics system as claimed in claim 8, wherein the first trigger is adjacent to the first antenna and the second trigger is adjacent to the second antenna, the first trigger and the second trigger are infrared detectors, when the first trigger and the second trigger detect goods approaching, and therefore output a high level trigger signal to the collecting module; when the first trigger and the second trigger do not detect goods approaching, and therefore output a low level trigger signal to the collecting module.

10. The logistics system as claimed in claim 8, wherein when the first trigger interface of the collecting module receives trigger signals from low level signal to high level signal, that is the first trigger detects goods is approaching, that means the goods is loading to the vehicle, thereby the collecting module triggers the first antenna to continuously read sort information from the sort tag of the goods in a predetermined period.

11. The logistics system as claimed in claim 10, wherein when the first trigger interface and the second trigger interface of the collecting module both receive trigger signals from low level signal to high level signal, that is the first trigger and the second trigger both detect goods are approaching, that means the two units of goods are loading to the vehicle, thereby the collecting module triggers the first antenna and the second antenna to continuously read sort information from sort tags of the two units of goods in a predetermined period, respectively.

12. The logistics system as claimed in claim 11, wherein when the first trigger interface and the second trigger interface of the collecting module both receive trigger signals from high level signal to low level signal, or the first trigger interface receives trigger signals from high level signal to low level signal and the second trigger interface receives continuous low lever trigger signals, that is the first trigger detects goods is unloading, thereby the collecting module triggers the third antenna and the fourth antenna to continuously read position information from the position tag and sort information from the sort tag of the goods in a predetermined period.

13. The logistics system as claimed in claim 12, wherein the collecting module determines positions of the goods according to the position information and the sort information read by the antenna module, therefore, the collecting module captures the loading status of the goods according to the determined positions.

14. The logistics system as claimed in claim 13, wherein when the first trigger interface and the second interface continuously receives same level trigger signals in a predetermined period, the collecting module automatically turn to a standby mode for saving power.

15. The logistics system as claimed in claim 1, wherein the control unit is an industrial personal computer (IPC) mounted in a driver's cab of the vehicle and provides parameter of the logistics system to the driver.

16. The logistics system as claimed in claim 1, wherein the control unit at least includes a Bluetooth® module, a Wi-Fi module or a wireless communication module for communicating with the data collection unit and the IOT system.

17. A logistics system wirelessly communicated with an internet of things (ITO) system, the logistics system comprising:
a tag unit coupled to goods and configured to store tag information of the goods, the tag information comprising sort information and position information of the goods;
a data collection unit coupled to a vehicle and configured to read the tag information of the goods from the tag unit and determine loading status of the goods; and
a control unit wirelessly communicated with the data collection unit and the ITO system;
wherein when the goods is loading to the vehicle, the data collection unit read the sort information from the tag unit of the goods; when the goods is unloading from the vehicle, the data collection unit read the sort information and the position information from the tag unit of the goods; and then the control unit receiving the tag information and the loading status of the goods from the data collection unit and synchronizing to the ITO system.

18. The logistics system as claimed in claim 17, wherein the data collection unit comprises a communication module, a collecting module, a power source module, an antenna module and a trigger module; the trigger module is electrically connected to the communication module, the antenna module and the trigger module.

19. The logistics system as claimed in claim 18, wherein the antenna module comprises a first antenna, a second antenna, a third antenna and a fourth antenna electrically connected to the collecting module; the first antenna and the second antenna are configured to read sort information from the sort tag of the goods on the vehicle; the third antenna and the fourth antenna are configured to read sort information from the sort tag and position information from the information tag of the goods.

20. The logistics system as claimed in claim 18, wherein the trigger module is configured to identify the loading status of the goods and further triggers the antenna module to read the tag information from the tag unit according to the loading status; the trigger module comprises a first trigger and a second trigger electrically connected to the collecting module and configured to transmit trigger signals to the collecting module.
